(19) United States
(12) Patent Application Publication
(10) Pub. No.: US 2022/0407884 A1
(43) Pub. Date: Dec. 22, 2022

(54) DEVICE COMMUNICATION CLASS BASED NETWORK SECURITY

(71) Applicant: British Telecommunications Public Limited Company, London (GB)

(72) Inventors: Fadi EL-MOUSSA, London (GB); Yipeng CHENG, London (GB)

(21) Appl. No.: 17/756,033

(22) PCT Filed: Nov. 10, 2020
(86) PCT No.: PCT/EP2020/081624

§ 371 Date: May 13, 2022

(30) Foreign Application Priority Data
Nov. 13, 2019 (GB) 1916466.4

(51) Int. Cl. H04L 9/40; H04L 67/51

(52) U.S. Cl. CPC H04L 63/1433; H04L 67/51

(57) ABSTRACT

A computer implemented method of computer security for a network-connected device communicating via a computer network, by accessing one or more attributes of communication over the network by the device, the communication according with one or more service discovery protocols; classifying the device based on the attributes, the classification having associated a predetermined set of acceptable states of operation of the device; deploying security measures for the device responsive to a detection of a deviation of a state of operation of the device from the acceptable states of operation, wherein the classification is made using a supervised machine learning method trained using training data for a plurality of training network-connected devices each having associated one or more attributes of communication over a network according with the one or more service discovery protocols, and each device having associated a definition of a set of acceptable states of operation.

### PRIORITY CLAIM

The present application is a National Phase entry of PCT Application No. PCT/EP2020/081624, filed Nov. 10, 2020, which claims priority from GB Patent Application No. 1916466.4, filed Nov. 13, 2019, each which is hereby fully incorporated herein by reference.

### BACKGROUND

Automated network security for local networks, such as a home network, apply rules to classify communicating devices in order to impose predetermine security controls in dependence on each device class. For example, devices can be classified as: predominantly traffic sinks (e.g. media streaming devices); predominantly traffic sources (e.g. internet cameras); high traffic volume devices (e.g. video players); low traffic volume devices (e.g. internet telephone); high traffic frequency devices (e.g. smartphones); and other classes. Security controls can be applied automatically to devices according to their classification as a means to provide first-level security without intervention of a network operator. For example, deviations from normal network communication can be flagged and stopped.

Improvements to such techniques are desirable.

### SUMMARY

According to a first aspect of the present disclosure, there is a provided a computer implemented method of computer security for a network-connected device communicating via a computer network, the method comprising: accessing one or more attributes of communication over the network by the device, the communication according with one or more service discovery protocols; classifying the device based on the attributes, the classification having associated a predetermined set of acceptable states of operation of the device; deploying security measures for the device responsive to a detection of a deviation of a state of operation of the device from the acceptable states of operation, wherein the classification is made using a supervised machine learning method trained using training data for a plurality of training network-connected devices each having associated one or more attributes of communication over a network according with the service discovery protocol, and each device having associated a definition of a set of acceptable states of operation.

In embodiments, the service discovery protocols include the Simple Service Discovery Protocol (SSDP).

In embodiments, the service discovery protocols include universal Plug and Play (uPnP) protocols.

In embodiments, the attributes include one or more of: a number of messages communicated with the device; a number of messages communicated by the device; a number of messages communicated to the device; a volume of data in communication with the device; a number of hypertext transport protocol—unicast (HTTPU) requests issued by the device; and one or more particular message types in communication with the device.

In embodiments, security measures include one or more of: any of interrupting, filtering, intercepting, precluding and flagging communications with the device; any of scanning, parsing, searching and logging communications with the device; and disconnecting the device from the network.

In embodiments, the supervised machine learning method is a recurrent neural network such as a long-short term memory (LSTM).

In embodiments, the supervised machine learning method includes a support vector machine (SVM).

According to a second aspect of the present disclosure, there is a provided a computer system including a processor and memory storing computer program code for performing the method set out above.

According to a third aspect of the present disclosure, there is a provided a computer system including a processor and memory storing computer program code for performing the method set out above.

### BRIEF DESCRIPTION OF THE FIGURES

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for providing computer security for a network-connected device in accordance with embodiments of the present disclosure.

FIG. 3 is a flowchart of a method of computer security for a network-connected device in accordance with embodiments of the present disclosure.

FIG. 4 is a component diagram of an arrangement for providing computer security for a network-connected device in accordance with embodiments of the present disclosure.

FIG. 5 is a flowchart of a method of computer security for a network-connected device in accordance with embodiments of the present disclosure.

### DETAILED DESCRIPTION

First-line defence automated network security for local networks depends on an appropriate classification of network-connected devices as they are introduced to, or discovered in, the network. For example, a media access control (MAC) address may be employed to classify a device. A MAC address includes a vendor portion and a device portion and devices can be classified based on their vendor on the basis that, for example, a vendor may specialize in a particular class of device. This is increasingly unreliable as vendors develop devices across many use cases.

The challenge of appropriate device classification is compounded by an increasing number of devices connecting to computer networks such as internet of things (IoT) devices. IoT devices can be many and varied ranging from devices with specific application such as an internet camera, presence sensor or the like, to integrated connectivity in conventional devices such as smart televisions, smart appliances (cookers, fridges etc.), smart toys etc. Such devices can appear on, and disappear from, a network very quickly and with high frequency and a network operator may defer to automated security measures for such devices rendering appropriate classification critical in first-line security.

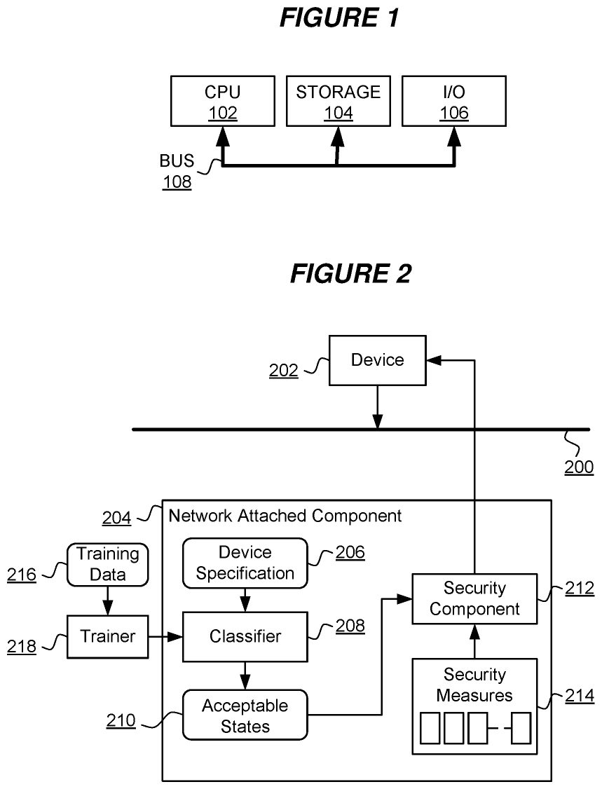

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for providing computer security for a network-connected device 202 in accordance with embodiments of the present disclosure. The network-connected device 202 can be any suitable device operable to communicate via a computer network 200 such as a wired, wireless or combination network. For example, the device 202 can be a computer system whether generalized or dedicated in nature, including pervasive devices, internet of things (IoT) devices, smart appliances, network appliances or components, components of network-connected vehicles, telephony or other communications devices, user terminal equipment, or any other suitable device as will be apparent to those skilled in the art.

A further network attached component 204 is provided such as a network appliance, router, network security component, firewall, proxy, or other suitable computer system. The component 204 provides security facilities for the device 202 and, as such, can be provided with, as part of, or in conjunction with the device 202. Alternatively, the component 204 can be provided as part of the network 200 or as part of one or more services or facilities provided via the network 200 such as a domestic network router, access point or network hub, a switch, security server or the like.

Notably, either or both the device 202 and component 204 can be provided as physical devices, virtual devices, or combination of physical and virtual devices. Further, while the component 204 is depicted in FIG. 2 as including other features 206 to 214 it will be appreciated by those skilled in the art that such other features may be provided by other, further, components or the device 202 itself and the arrangement of FIG. 2 is not to be considered limiting on the particular configuration of the component 204.

In use, the component 204 provides, obtains, accesses, or generates a classifier 208 as one or more software components for classifying input data sets into classes as output data. The classifier 208 is provided by way of a machine learning method such as a recurrent neural network as will be apparent to those skilled in the art. For example, the classifier 208 is a long-short-term memory (LSTM) or a support vector machine (SVM). In accordance with embodiments of the present disclosure, the classifier 208 is arranged to classify a device specification 206 into a class of device, each class of device having associated a set 210 of acceptable states of operation of a device within such class. These features are considered in more detail below.

The device specification 206 is a specification of a set of service supported by the device 202. In one embodiment, the specification 206 is obtained by way of a service discovery protocol such as the Simple Service Discovery Protocol (SSDP) specified by the Internet Engineering Taskforce (IETF) (available at tools.ietf.org/pdf/draft-cai-ssdp-v1-03.pdf) according to which “the SSDP provides a mechanism whereby network clients, with little or no static configuration, can discover network services. SSDP accomplishes this by providing for multicast discovery support as well as server based notification and discovery routing.” Thus, using SSDP or any suitable service discovery protocol, a specification of a set of services supported by the device 202 can be obtained. For example, using SSDP such specification can take the form of an extensible markup language (XML) document specifying supported services, and thus would constitute a textual specification.

Thus, in use, the classifier 208 is operable to classify the device 202 on the basis of the device specification 206 for the device 202. To achieve this, the classifier 208 is trained by a trainer component 218 as a hardware, software, firmware, or combination component arranged to train the classifier 208 on the basis of training data 216. The training data 216 includes device specifications for a range of devices such that devices exhibiting commonality in respect of their specifications may be classified in like classes. Such training processes for machine learning methods are known to those skilled in the art.

For each class to which devices may be classified by the classifier 208, a set of acceptable states of operation 210 for the devices is associated with the class. An acceptable state of operation is a state of operation of a device in a class that is determined to be normal, typical, usual or non-deviant for devices in the class. Such determinations can be made based on prior analysis of devices in operation and may, in some embodiments, themselves arise from a machine learning method on which basis typical behaviours are learned. For example, behaviours can be characterized in terms of: resource consumption of devices such as processor, memory, network bandwidth and the like; network activity such as a number of, frequency or and/or nature of network communications performed by, with or via devices; a frequency of connection, disconnection and/or a duration of connection of devices; and other operational characteristics of devices as will apparent to those skilled in the art.

Thus, in use, the component 204 is operable to access or receive a device specification 206 for the device 202, such as based on communication with the device 202 using the SSDP protocol including, for example: one or more SSDP “SEARCH” messages; one or more SSDP “NOTIFY” messages; and one or more service requests under the SSDP protocol. Further, the component 204 is operable to classify the device 202 by way of the classifier 208 based on the device specification 206 to determine a set of acceptable states of operation for the device 202. The component 204 additionally includes a security component 212 as a hardware, software, firmware or combination component arranged to provide security services for the device 202. In particular, the security component 212 is operable to implement security measures 214 in respect of the device 202 where the device 202 is determined to have a state of operation that deviates from the acceptable states of operation 210 for the device as determined based on the classification of the device by the classifier 208. Such deviation represents, for example, a state of operation of the device 202 that is inconsistent with acceptable states of operation 210.

Security measures are processes, procedures, operations, facilities, configuration changes, constraints or other measures as may be employed and/or effected by the security component 212 in respect of the device 202. For example, security measures 214 can be effected to mitigate a potential attack, vulnerability or other security threat in respect of the device 202 indicated by an operation of the device 202 outside the set of acceptable states of operation 210. For example, security measures can include one or more of: any of interrupting, filtering, intercepting, precluding, and flagging communications with the device; any of scanning, parsing, searching and logging communications with the device; disconnecting the device from the network; and other security measures as will be apparent to those skilled in the art.

Thus, in this way, the device 202 is classified automatically on the basis of security services supported by the device to determine a set of acceptable states of operation 210 on which basis security measures 214 can be deployed to provide protection for the device 202 or the network 200 from security threats.

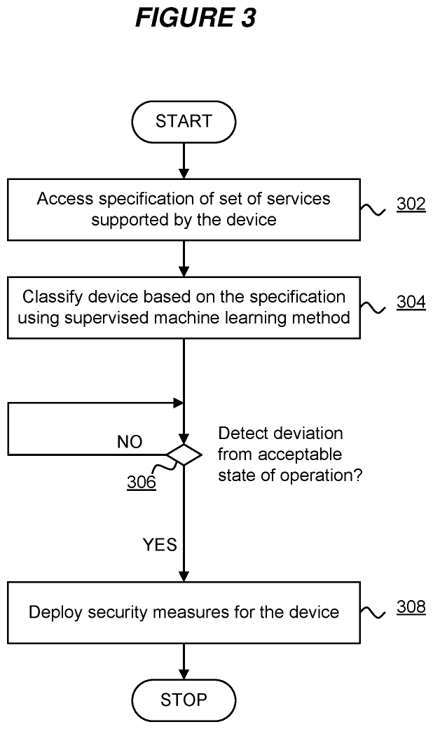

FIG. 3 is a flowchart of a method of computer security for a network-connected device in accordance with embodiments of the present disclosure. Initially, at step 302, the method accesses a specification 206 of a set of services supported by the device 202, the specification 206 being determined based on a communication with the device using one or more service discovery protocols. At step 304 the method classifies the device 202 based on the specification 206, the classification having associated a predetermined set of acceptable states of operation 210 of the device 202. Security measures for the device 202 are deployed at step 308 responsive to a detection, at step 306, of a deviation of a state of operation of the device 202 from the acceptable states of operation 210.

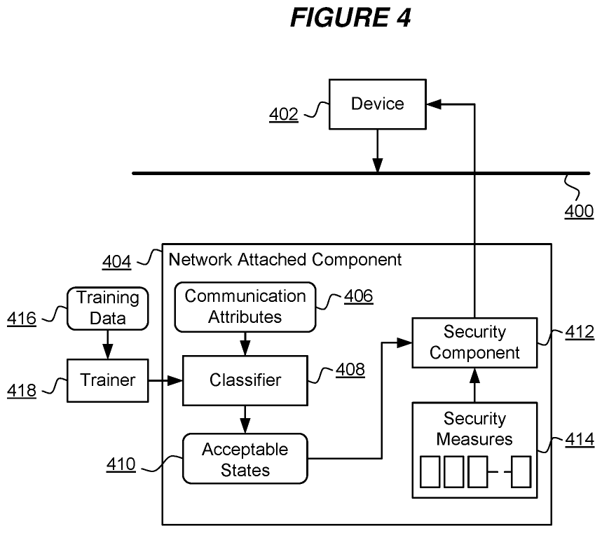

FIG. 4 is a component diagram of an arrangement for providing computer security for a network-connected device in accordance with embodiments of the present disclosure. Many of the elements of FIG. 4 are identical to those described above with respect to FIG. 2 and these will not be repeated here. FIG. 4 differs in that the classifier 408 is differently configured to classify the device 402 on the basis of attributes 406 of communications undertaken by the device 402, as will be described below. Thus, this differing basis for the classification of the device 402 in FIG. 4 requires a different basis in the training data 416 for training the classifier 408 by the trainer 418 such that the training data 416 includes communication attributes of training devices. Notably, the nature of the classifier 408 for classifying the device 402 into a class having associated a set 410 of acceptable states of operation is unchanged vis-à-vis FIG. 2.

The communication attributes 406 are attributes of communication performed by the device 402 when the device is communicating in accordance with a service discovery protocol such as the SSDP or, in particular, the Universal Plug and Play (uPnP) protocol. Such attributes 406 can include raw communications data from a portion of communication performed according to such protocols—such portion being predetermined and consistently used in both classifying functions of the component 404 and training functions of the trainer 418. For example, a setup portion of communication under the uPnP protocol may be employed, where such setup portion can be specifically defined in terms of a stage or phase of communication under a uPnP communications procedure. For example, uPnP communications with devices can be considered as taking place in a number of phases as outlined in the presentation “UPnP Technical basics: UPnP Device Architecture (UDA)” (UPnP Forum, upnp.org, July 2014, available at www.upnp.org/resources/documents/UPnP_UDA_tutorial_July2014.pdf). Such phases include: discovery; description; control; and protocol. Thus, one or more of these phases may be considered a requisite portion of communication under the uPnP protocol for the purpose of determining characteristics of the communication as attributes 406 thereof. While the attributes of the communication 406 can include raw communication data, depending upon the nature of a machine learning algorithm employed for the classifier 408, attributes can alternatively or additionally include one or more of, inter alia: a number of messages communicated with the device 402; a number of messages communicated by the device 402; a number of messages communicated to the device 402; a volume of data in the communication; a number of HTTPU (hypertext transport protocol—unicast) requests issued; one or more particular message types; and other attributes as will be apparent to those skilled in the art. In embodiments, the attributes selected for the classifier 408 are determined based on their suitability for classifying the device 402.

Thus, according to the arrangement of FIG. 4, the device 402 is classified automatically on the basis of communication attributes 406 to determine a set of acceptable states of operation 410 on which basis security measures 414 can be deployed to provide protection for the device 402 or the network 400 from security threats.

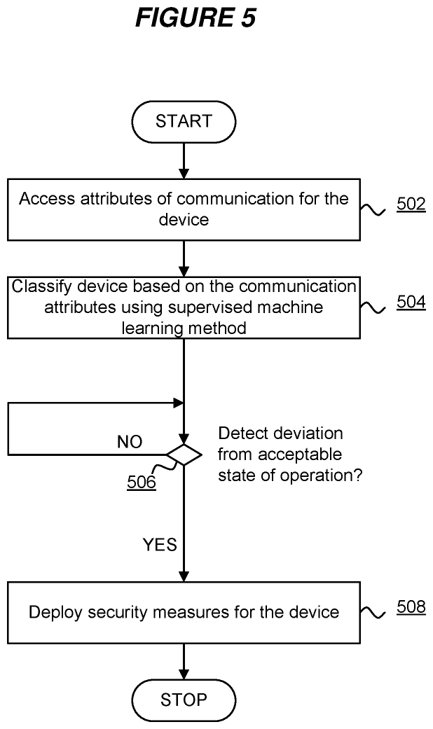

FIG. 5 is a flowchart of a method of computer security for a network-connected device in accordance with embodiments of the present disclosure. Initially, at step 502, the method accesses communication attributes 406 for the device 402, the attributes 406 being determined based on a communication with the device 402 using one or more service discovery protocols. At step 504 the method classifies the device 402 based on the attributes 506, the classification having associated a predetermined set of acceptable states of operation 510 of the device 402. Security measures for the device 402 are deployed at step 508 responsive to a detection, at step 506, of a deviation of a state of operation of the device 402 from the acceptable states of operation 410.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of computer security for a network-connected device communicating via a computer network, the method comprising:
accessing one or more attributes of communication over the computer network by the device, the communication using one or more service discovery protocols;
classifying the device based on the one or more attributes, the classification being associated with a predetermined set of acceptable states of operation of the device;
deploying security measures for the device responsive to a detection of a deviation of a state of operation of the device from the predetermined set of acceptable states of operation,
wherein the classification is made using a supervised machine learning method trained using training data for a plurality of training network-connected devices each being associated with the one or more attributes of communication over a network using the one or more service discovery protocols, and each device of the plurality of training network-connected devices being associated with a definition of a set of acceptable states of operation.

2. The method of claim 1, wherein the one or more service discovery protocols include the Simple Service Discovery Protocol (SSDP).

3. The method of claim 1, wherein the one or more service discovery protocols include universal Plug and Play (uPnP) protocols.

4. The method of claim 1, wherein the one or more attributes include one or more of: a number of messages communicated with the device; a number of messages communicated by the device; a number of messages communicated to the device; a volume of data in communication with the device; a number of hypertext transport protocol—unicast (HTTPU) requests issued by the device; and one or more particular message types in communication with the device.

5. The method of claim 1, wherein security measures include one or more of: interrupting, filtering, intercepting, precluding, or flagging communications with the device; scanning, parsing, searching, or logging communications with the device; and disconnecting the device from the network.

6. The method of claim 1, wherein the supervised machine learning method is a recurrent neural network such as a long-short term memory (LSTM).

7. The method of claim 1, wherein the supervised machine learning method includes a support vector machine (SVM).

8. A computer system comprising:
a processor and a memory storing computer program code for computer security of a network-connected device communicating via a computer network, by:
accessing one or more attributes of communication over the computer network by the device, the communication using one or more service discovery protocols;
classifying the device based on the one or more attributes, the classification being associated with a predetermined set of acceptable states of operation of the device;
deploying security measures for the device responsive to a detection of a deviation of a state of operation of the device from the predetermined set of acceptable states of operation,
wherein the classification is made using a supervised machine learning method trained using training data for a plurality of training network-connected devices each being associated with the one or more attributes of communication over a network using the one or more service discovery protocols, and each device of the plurality of training network-connected devices being associated with a definition of a set of acceptable states of operation.

9. A non-transitory computer-readable storage element storing computer program code to, when loaded into a computer system and executed thereon, cause the computer to perform the method of claim 1.
